(19) United States
(12) Patent Application Publication
(10) Pub. No.: US 2014/0244374 A1
(43) Pub. Date: Aug. 28, 2014

(54) TECHNIQUES FOR VOUCHER OR REBATE REDEMPTION

(71) Applicant: NCR CORPORATION, Duluth, GA (US)

(72) Inventor: Roger Webster Morris, Smyrna, GA (US)

(73) Assignee: NCR Corporation, Duluth, GA (US)

(21) Appl. No.: 13/780,440

(22) Filed: Feb. 28, 2013

(51) Int. Cl. G06Q 30/02

(52) U.S. Cl. CPC G06Q 30/0225
USPC 705/14.26; 705/14.37

(57) ABSTRACT

Techniques for voucher or rebate redemption are provided. An enterprise system electronically distributes an encoded voucher or rebate to a device of a consumer. In an embodiment, the consumer electronically presents the encoded rebate or voucher at a kiosk, via the device, and receives a card preloaded with a value for the voucher or the rebate. In another case, the consumer electronically presents the encoded rebate or voucher at a retailer, via the device, during a transaction and a value for the voucher or the rebate is debited based on the transaction.

### BACKGROUND

Consumers are increasingly using kiosks to conduct business with enterprises. The kiosks come in a variety of sizes and are used for a variety of purposes. Some kiosks are drive through, such as fast food establishments, pharmacies, banks, and the like. Other kiosks are stationary located in gas stations, airlines, grocery stores, department stores, and the like.

In addition, what is considered a kiosk is evolving with today's technology. For example, digital signs now provide advertisements and mechanisms for users to interact with the displays to perform transactions.

For the most part kiosks still largely interact with a consumer via some consumer-driven input mechanism, such as a touch screen. That is, the kiosks do not typically interact with existing electronic devices possessed by the consumer, such as consumer smart phones. So, many retailers and kiosk manufacturers are not taking advantage of the full potential of these consumer mobile devices when viewed with the current capabilities of consumers having mobile devices that can perform a variety of mobile communication and processing.

Additionally, many retailers, for a variety of reasons, often have to provide their consumers with vouchers or rebates for exception situations that can occur in their businesses. For example, consider the airline industry that can face an interruption in operations at any time for a variety of reasons; some of which are within their control (mechanical issues) and some of which that are not within their control (weather or political issues).

Under such situations, an airline will likely distribute vouchers to passengers for things such as meals, transportation, lodging, etc. These vouchers are created and dispensed in paper format to the passengers at the gates. As a result, airline personnel have to: manage a gate (that may now be canceled) to provide the vouchers to the displaced passengers, manage printers, handle supplies for the printers, and handle paper receipts representing the vouchers. In addition, the airline as a whole has to maintain legal agreements with airport vendors to honor any such vouchers and put internal staff and procedures in place to make payment to vendors for honoring these vouchers. In addition, these vouchers: can be easily counterfeited, used by individuals for which they were not intended (e.g., friends of a displaced passenger), and/or can remain active and unprocessed for extended periods of time (if expiration dates for the vouchers are not clearly communicated on the printed vouchers).

### SUMMARY

In various embodiments, techniques for voucher or rebate redemption are presented. According to an embodiment, a method for voucher or rebate redemption is provided.

Specifically, an electronic voucher is received and that voucher is stored on the mobile device. Next, the electronic voucher is communicated to a kiosk for dispensing a pre-loaded debit card having a value identified by the electronic voucher.

### BRIEF DESCRIPTION OF THE DRAWINGS

FIG. 1 is a diagram of a method for voucher or rebate redemption, according to an example embodiment.

FIG. 2 is a diagram of another method for voucher or rebate redemption, according to an example embodiment.

FIG. 3 is a diagram of a voucher or rebate redemption system, according to an example embodiment.

### DETAILED DESCRIPTION

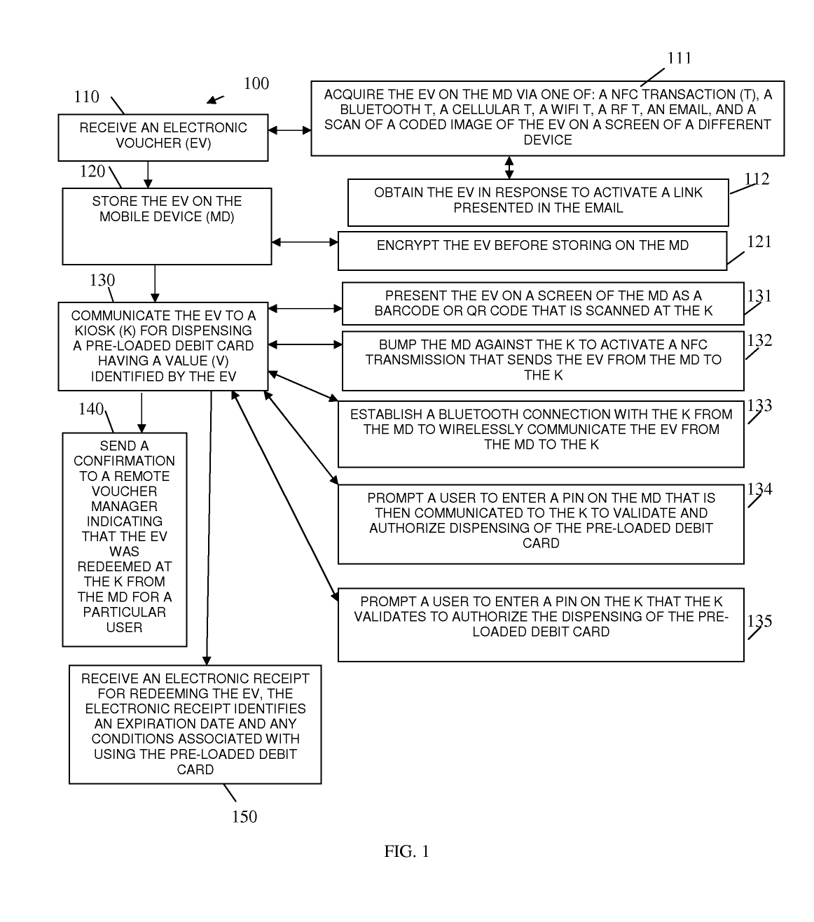

FIG. 1 is a diagram of a method 100 for voucher or rebate redemption, according to an example embodiment. The method 100 (hereinafter “voucher mobile app”) is implemented as instructions programmed and residing on a non-transitory computer-readable (processor-readable) storage medium and executed by one or more processors or a mobile device (e.g., smart phone, tablet, wearable device (glasses), etc.). The processors are specifically configured and programmed to process the voucher mobile app. The voucher mobile app operates over a network. The network is wireless.

The voucher mobile app processes or is initiated on a mobile device. In an embodiment, the voucher mobile app is processed via web pages in a mobile app that is a browser of the mobile device. In this latter embodiment, the processing of the voucher mobile app can occur on processors of the mobile device and also on remote servers that process the web pages and embedded applets from the browser. In another case, the voucher mobile app is a standalone application that processes on the mobile device independent of the mobile device's browser app.

As some initial context of a specific embodiment of the techniques presented herein, consider the following scenario.

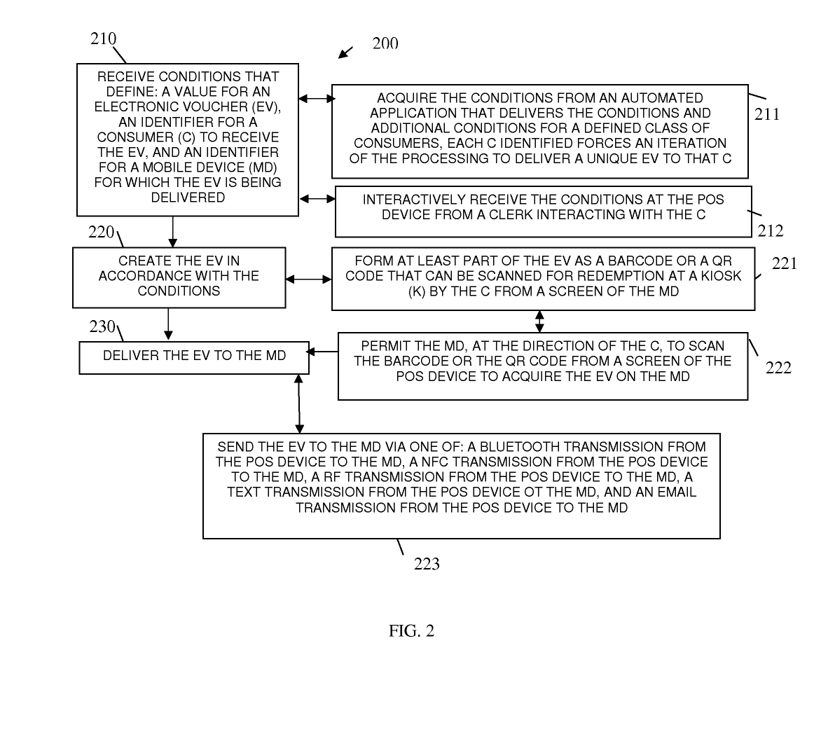

An Airline integrates a 2D (two-dimensional) barcode voucher delivery system with its existing mobile application. There is two mechanisms for redemption, but the primary redemption mechanism is scanning the 2D barcode at strategically located cash-to-card machines (kiosks) that dispense a pre-loaded debit card (Visa, MasterCard, or otherwise branded) for an amount specified (in some cases the customer can, of course, load more than the voucher amount out of his/her own cash). The initial delivery of the barcode and the redemption characteristics are integrated in a voucher manager (discussed below with reference to the FIG. 2). This allows for control over things such as where the barcode can be redeemed for a card, the expiration period on the voucher, and the amount to be loaded. A secondary redemption mechanism scans the barcode directly at retailers that are equipped with the necessary 2D barcode scanning technology.

At 110, the voucher mobile app receives an electronic voucher. As used herein, an electronic voucher can also be referred to as an electronic rebate. The mobile device that processes the voucher mobile app can receive the electronic voucher in a variety of different manners. An example scenario for which an enterprise may want to distribute an electronic voucher to a consumer was presented above with respect to the airline industry. It is noted that any enterprise or organization can have a need to distribute vouchers or rebates to consumers and all such situations are intended to fall within the generous scope of the embodiments presented herein.

According to an embodiment, at 111, the voucher mobile app acquires the electronic voucher on the mobile device as one of: a Near Field Communication (NFC) transaction, a Bluetooth transaction, a cellular transaction, a WiFi transaction, a Radio Frequency (RF) transaction, an email, a text, and a scan of a coded image of the electronic voucher that is scanned from a screen of a different device from the mobile device, such as a Point-of-Sale (POS) terminal screen.

Continuing with the embodiment of 111 and at 112, the voucher mobile app obtains the electronic voucher in response to an activated link presented in an email on the mobile device.

At 120, the voucher mobile app stores the electronic voucher on the mobile device. This can be done in a secure manner or in a non-secure manner.

For example, at 121, the voucher mobile app encrypts the electronic voucher before storing the electronic voucher on the mobile device.

At 130, the voucher mobile app communicates the electronic voucher to a kiosk for dispensing a pre-loaded debit card having a value identified by the electronic voucher.

In an embodiment, at 131, the voucher mobile app presents the electronic voucher on a screen of the mobile device as a barcode or a Quick Response (QR) code that is scanned at the kiosk.

In another case, at 132, the voucher mobile app detects a bump of the mobile device against the kiosk and that activates a NFC transmission that sends the electronic voucher from the mobile device to the kiosk.

In yet another situation, at 133, the voucher mobile app establishes a Bluetooth connection with the kiosk from the mobile device to wirelessly communicate the electronic voucher from the mobile device to the kiosk.

In some cases, at 134, the voucher mobile app can force a prompt of the user to enter a Personal Identification Number (PIN) on the mobile device that is then communicated to the kiosk to validate and authorize the dispensing of the pre-loaded debit card.

Alternatively, at 135, the voucher mobile app can force a prompt of the user to enter a PIN on the kiosk that the kiosk uses to validate and authorize the dispensing of the pre-loaded debit card.

According to an embodiment, at 140, the voucher mobile app sends a confirmation to a remote voucher manager that indicates that the electronic voucher was redeemed at the kiosk from the mobile device for a particular user. This permits a remote service, such as the voucher manager of the FIG. 2 below, to keep track of and just redeem a single instance of an electronic voucher once for a particular consumer/user and perhaps for a particular mobile device.

In an embodiment, at 150, the voucher mobile app receives an electronic receipt for redeeming the electronic voucher, the electronic receipt identifies an expiration date and any conditions associated with using the pre-loaded debit card. This permits the consumer to keep track of such details via an electronic receipt viewable via the voucher mobile app on the mobile device.

FIG. 2 is a diagram of another method 200 for voucher or rebate redemption, according to an example embodiment. The method 200 (hereinafter “voucher manager”) is implemented as instruction and programmed within a non-transitory computer-readable (processor-readable) storage medium that executes on one or more processors of Point-of-Sale (POS) devices, servers, clouds, or sets of devices (systems), such as: a assistant-manned device, set of devices, or any computing device for which a customer is being assisted; the processors of these devices are specifically configured to execute the voucher manager. The voucher manager is also operational over a network; the network is wired, wireless, or a combination of wired and wireless.

The voucher manager directly or indirectly interacts with the voucher mobile app described above with reference to the FIG. 1 to provide novel techniques for distributing vouchers or rebates to mobile devices of consumers. In an embodiment, the voucher manager may also interact with other systems of an enterprise, such as loyalty systems, payment systems, and the like.

At 210, the voucher manager receives conditions that define: a value for an electronic voucher, an identifier for a consumer to receive the electronic voucher, and an identifier for a mobile device for which the electronic voucher is being delivered.

According to an embodiment, at 211, the voucher manager acquires the conditions from an automated application that delivers the conditions and additional conditions for a defined class of consumers. Each consumer identified forces an interaction of the voucher manager (the method 200) to deliver a unique electronic voucher to that consumer. Here, an enterprise may define conditions that award a defined group (class of consumers) entitled to an electronic voucher and have an automated application engage the voucher manager to process each voucher for each consumer.

Alternatively, at 212, the voucher manager interactively receives the conditions at the POS device (which processes the voucher manager) from a clerk interacting with the consumer. This may be useful for a one-off voucher that an enterprise is giving to a consumer for whatever reason.

At 220, the voucher manager creates the electronic voucher in accordance with the conditions.

According to an embodiment, at 221, the voucher manager forms at least a part of the electronic voucher as a barcode or QR code that can be scanned for redemption at a kiosk by the consumer from a screen of the mobile device that presents the barcode or QR code.

Continuing with the embodiment of 221 and at 222, the voucher manager permits the mobile device (at the direction of the consumer) to scan the barcode or the QR code from a screen of the POS device to acquire initially acquire the electronic voucher on the mobile device.

At 230, the voucher manager delivers the electronic voucher to the mobile device (one mechanism for receipt of the voucher was discussed above at 222).

According to an embodiment, at 231, the voucher manager sends the electronic voucher to the mobile device via one of: a Bluetooth transmission from the POS device to the mobile device, a NFC transmission from the POS device to the mobile device, a RF transmission from the POS device to the mobile device, a text transmission from the POS device to the mobile device, and an email transmission from the POS device to the mobile device.

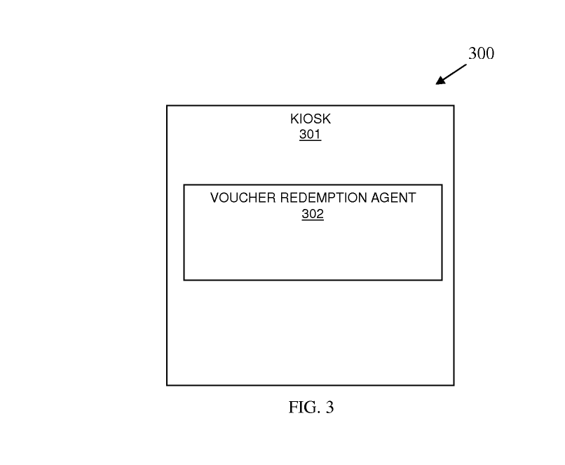

FIG. 3 is a diagram of a voucher or rebate redemption system 300, according to an example embodiment. The components of the voucher or rebate redemption system 300 are implemented as executable instructions and programmed within a non-transitory computer-readable (processor-readable) storage medium that execute on one or more processors of a kiosk; the processors of the kiosk are specifically configured to execute the components of the voucher or rebate redemption system 300. The voucher or rebate redemption system 300 may also be operational over a network; the network is wired, wireless, or a combination of wired and wireless.

The voucher or rebate redemption system 300 includes a kiosk 301 and a voucher redemption agent 302. Each of these components and the interactions of each component are now discussed in turn.

The voucher or rebate redemption system 300 includes a kiosk 301 having one or more processors, memory, and/or storage. The kiosk 301 includes an input mechanism for retrieving an electronic voucher or rebate directly from a mobile device of a consumer. Example processing associated with delivery of the voucher or rebate to the mobile device and use of the voucher or rebate from the mobile device were presented above with respect to the FIGS. 2 and 1, respectively.

In an embodiment, the input mechanism of the kiosk 301 is a barcode or Quick Response (QR) code scanner, a Near Field Communication (NFC) driver, a Bluetooth driver, and/or a Radio Frequency (RF) reader/driver.

The kiosk 301 includes memory and/or non transitory media having the voucher redemption agent 302, which executes as executable instructions on the processors of the kiosk 301. The voucher redemption agent 302 is configured to obtain the voucher or rebate from the input mechanism; validate the voucher or rebate; load a redemption card (such as a preloaded debit card) with a value associated with the voucher or rebate; and instruct the kiosk 301 to dispense the loaded redemption card to a consumer.

In an embodiment, the voucher redemption agent 302 interacts with a voucher manager, such as the voucher manager of the FIG. 2, to validate the voucher or the rebate. In some instances, an identifier for the mobile device having the voucher or rebate is used to validate or partially validate the voucher or rebate. So, the voucher or rebate may be encoded such that it can just be redeemed from a specific mobile device for which it was delivered. In another case, the voucher redemption agent 302 may prompt the consumer, via the kiosk 301, to enter a Personal Identification Number (PIN), with the voucher or rebate for purposes of validating an identity of the consumer; here, the voucher or rebate can be directly tied to the consumer for which it was originally delivered.

In an embodiment, the voucher redemption agent 302 decrypts the voucher or rebate based on an identifier associated with one or more of: a distributor of the voucher, a specific mobile device, the kiosk 301, and/or a specific consumer.

The voucher manager of the FIG. 2 dynamically and electronically distributes vouchers or rebates to consumers via their voucher mobile apps that process on their mobile devices. The processing of the mobile apps was discussed with the FIG. 1. The mobile apps then automatically or semi automatically communicate the vouchers or rebates to the kiosk 301, which the voucher redemption agent 302 validates and then causes the kiosk 301 to electronically load value associated with the voucher or rebate to a debit card, which is then automatically dispensed to the consumer via the kiosk 301.

This approach is a lot more amenable to the business operations of enterprises because: 1) agreements with vendors are not needed (the value is on a universal debit or credit card usable at most retailers); 2) retail staff to process vouchers are not needed (consumers have cash on the cards nothing to process); and 3) electronic services (voucher manager of the FIG. 2) and instances of the voucher mobile apps (voucher mobile app of the FIG. 1) automatically deliver and manage the vouchers or rebates. So, retailers can eliminate exception processing that can be very expensive, with the techniques presented herein, and consumers are more satisfied because they have cash (cash equivalent on preloaded debit or credit card) and because receipt and use of the preloaded debit or credit card is easier to deal with than a paper coupon.

In fact, there are a variety of advantages with the techniques presented herein for voucher or rebate redemption. The techniques provide for: 1) the delivery of a 2D (two dimensional) barcode (or QR code) directly to the customer's mobile device creating a better customer experience (instant notification and no queuing for paper vouchers); 2) eliminates the need for paper vouchers for these customers; 3) reduces staffing needs of a retailer; 4) creates a larger opportunity for breakage due to the difficulty in transferring the 2D barcode and the ability to set tight redemption windows; 4) reduces the opportunity for counterfeit vouchers due to the integrated nature of the solution; 5) presents the customer with a major credit branded debit card, which can be used anywhere inside or outside of the airport, increasing customer satisfaction, which also means the Airline does not have to maintain the vendor relationships to honor the voucher; and/or 6) making cash or the cash equivalent available to customers so that they are being utilized even during non-irregular operation (non-IROP) situations.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A processor-implemented method programmed in a non-transitory processor-readable medium and to execute on one or more processors of a mobile device configured to execute the method, comprising:
receiving, at the mobile device, an electronic voucher;
storing, on the mobile device, the electronic voucher; and
communicating, from the mobile device, the electronic voucher to a kiosk for dispensing a pre-loaded debit card having a value identified by the electronic voucher.

2. The method of claim 1, wherein receiving further includes acquiring the electronic voucher on the mobile device via one of: a near field communication (NFC) transaction, a Bluetooth transaction, a cellular transaction, a WiFi transaction, a Radio Frequency (RF) transaction, an email, and a scan of a coded image of the electronic voucher on a screen of a different device.

3. The method of claim 2, wherein acquiring further includes obtaining the electronic voucher in response to activating a link presented in the email.

4. The method of claim 1, wherein storing further includes encrypting the electronic voucher before storing on the mobile device.

5. The method of claim 1, wherein communicating further includes presenting the electronic voucher on a screen of the mobile device as a barcode or Quick Response (QR) code that is scanned at the kiosk.

6. The method of claim 1, wherein communicating further includes bumping the mobile device against the kiosk to activate an Near Field Communication (NFC) transmission that sends the electronic voucher from the mobile device to the kiosk.

7. The method of claim 1, wherein communicating further includes establishing a Bluetooth connection with the kiosk from the mobile device to wirelessly communicate the electronic voucher from the mobile device to the kiosk.

8. The method of claim 1, where communicating further includes prompting a user to enter a personal identification number (PIN) on the mobile device that is communicated to the kiosk to validate and authorize dispensing of the pre-loaded debit card.

9. The method of claim 8, wherein communicating further includes prompting a user to enter a personal identification number (PIN) on the kiosk that the kiosk validates to authorize the dispensing of the pre-loaded card.

10. The method of claim 1 further comprising, sending, via the mobile device, a confirmation to a remote voucher manager indicating that the electronic voucher was redeemed at the kiosk from the mobile device and for a particular user.

11. The method of claim 1 further comprising, receiving, at the mobile device, an electronic receipt for redeeming the electronic voucher, the electronic receipt identifying an expiration date and any conditions associated with using the pre-loaded debit card.

12. A processor-implemented method programmed in a non-transitory processor-readable medium and to execute on one or more processors of a Point-Of-Sale (POS) device configured to execute the method, comprising:
receiving, on the POS device, conditions defining: a value for an electronic voucher, an identifier for a consumer to receive the electronic voucher, and an identifier for a mobile device for which the electronic voucher is to be delivered;
creating, via the POS device, the electronic voucher in accordance with the conditions; and
delivering, via the POS device, the electronic voucher to the mobile device.

13. The method of claim 12, wherein receiving further includes acquiring the conditions from an automated application that delivers the conditions and additional conditions for a defined class of consumers, each consumer identified forces an iteration of the method to deliver a unique electronic voucher to that consumer.

14. The method of claim 12, wherein receiving further includes interactively receiving the conditions at the POS device from a clerk interacting with the consumer.

15. The method of claim 12, wherein creating further includes forming at least part of the electronic voucher as a barcode or a Quick Response (QR) code that can be scanned for redemption at a kiosk by the consumer from a screen of the mobile device.

16. The method of claim 15, wherein delivering further includes permitting the mobile device at the direction of the consumer to scan the barcode or QR code from a screen of the POS device to acquire the electronic voucher on the mobile device.

17. The method of claim 12, wherein delivering further includes sending the electronic voucher to the mobile device via one of: a Bluetooth transmission from the POS device to the mobile device, a Near Field Communication (NFC) transmission from the POS device to the mobile device, a Radio Frequency (RF) transmission from the POS device to the mobile device, a text transmission from the POS device to the mobile device, and an email transmission from the POS device to the mobile device.

18. A system comprising:
a kiosk; and
the kiosk having memory configured with a voucher redemption agent that executes on one or more processors of the kiosk;
wherein the kiosk is configured to automatically acquire an electronic voucher from a mobile device and deliver the electronic voucher to the voucher redemption agent, the voucher redemption agent is configured to validate the electronic voucher and redeem the electronic voucher as a pre-loaded debit card having a value represented in the electronic voucher, the voucher redemption agent also configured to instruct the kiosk to dispense the pre-loaded debit card to a consumer at the kiosk.

19. The system of claim 18, wherein the voucher redemption agent is configured to use an identifier associated with the mobile device to decode and validate the electronic voucher.

20. The system of claim 18, wherein the voucher redemption agent is configured to prompt the consumer via the mobile device or the kiosk to enter a personal identification number (PIN) when validating the electronic voucher.
